(19) United States
(12) Patent Application Publication
(10) Pub. No.: US 2019/0260504 A1
(43) Pub. Date: Aug. 22, 2019

(54) SYSTEMS AND METHODS FOR MAINTAINING NETWORK-ON-CHIP (NOC) SAFETY AND RELIABILITY

(71) Applicant: NetSpeed Systems, Inc., San Jose, CA (US)

(72) Inventors: Joji Philip, San Jose, CA (US); Joseph Rowlands, San Jose, CA (US); Sailesh Kumar, San Jose, CA (US)

(73) Assignee: NetSpeed Systems, Inc.

(21) Appl. No.: 16/265,948

(22) Filed: Feb. 1, 2019

Related U.S. Application Data
(60) Provisional application No. 62/634,076, filed on Feb. 22, 2018.

(51) Int. Cl. H04L 1/00

(52) U.S. Cl. CPC H04L 1/0041; H04L 1/0063; H04L 1/0045

(57) ABSTRACT

Methods and example implementations described herein are directed to systems and methods for maintaining network-on-chip (NoC) safety and reliability. An aspect of the present disclosure relates to an network-on-chip (NoC)-based error correction system capable of supporting a network interface (NI) that transmits a flit between a transmission side (Tx) intellectual property (IP) element and a receiving side (Rx) IP element. The system includes an encoder configured to receive a k-bit flit from the Tx IP element and encodes the k-bit flit into n-bit data (where k and n denote any natural numbers), and a decoder configured to receive the n-bit data, decode the n-bit data into the k-bit flit, and output the k-bit flit, the decoder having an error correction circuit for correcting an error in the n-bit data. In an aspect, the error correction circuit comprises a multiple overlapping layers of coverage configured for the NoC transport infrastructure.

### CROSS REFERENCE TO RELATED APPLICATION

This U.S. patent application is based on and claims the benefit of domestic priority under 35 U.S.C 119(e) from provisional U.S. patent application No. 62/634,076, filed on Feb. 22, 2018, the disclosure of which is hereby incorporated by reference herein in its entirety.

### TECHNICAL FIELD

Methods and example implementations described herein are generally directed to interconnect architecture, and more specifically, to systems and methods for maintaining network-on-chip (NoC) safety and reliability.

### RELATED ART

The number of components on a chip is rapidly growing due to increasing levels of integration, system complexity and shrinking transistor geometry. Complex System-on-Chips (SoCs) may involve a variety of components e.g., processor cores, DSPs, hardware accelerators, memory and I/O, while Chip Multi-Processors (CMPs) may involve a large number of homogenous processor cores, memory and I/O subsystems. In both SoC and CMP systems, the on-chip interconnect plays a role in providing high-performance communication between the various components. Due to scalability limitations of traditional buses and crossbar based interconnects, Network-on-Chip (NoC) has emerged as a paradigm to interconnect a large number of components on the chip. NoC is a global shared communication infrastructure made up of several routing nodes interconnected with each other using point-to-point physical links.

Messages are injected by the source and are routed from the source node to the destination over multiple intermediate nodes and physical links. The destination node then ejects the message and provides the message to the destination. For the remainder of this application, the terms ‘components’, ‘blocks’, ‘hosts’ or ‘cores’ will be used interchangeably to refer to the various system components which are interconnected using a NoC. Terms ‘routers’ and ‘nodes’ will also be used interchangeably. Without loss of generalization, the system with multiple interconnected components will itself be referred to as a ‘multi-core system’.

There are several topologies in which the routers can connect to one another to create the system network. Bi-directional rings (as shown in FIG. 1A, 2-D (two dimensional) mesh (as shown in FIG. 1B), and 2-D Taurus (as shown in FIG. 1C) are examples of topologies in the related art. Mesh and Taurus can also be extended to 2.5-D (two and half dimensional) or 3-D (three dimensional) organizations. FIG. 1D shows a 3D mesh NoC, where there are three layers of 3×3 2D mesh NoC shown over each other. The NoC routers have up to two additional ports, one connecting to a router in the higher layer, and another connecting to a router in the lower layer. Router 111 in the middle layer of the example has its ports used, one connecting to the router 112 at the top layer and another connecting to the router 110 at the bottom layer. Routers 110 and 112 are at the bottom and top mesh layers respectively and therefore have only the upper facing port 113 and the lower facing port 114 respectively connected.

Packets are message transport units for intercommunication between various components. Routing involves identifying a path that is a set of routers and physical links of the network over which packets are sent from a source to a destination. Components are connected to one or multiple ports of one or multiple routers; with each such port having a unique identification (ID). Packets can carry the destination's router and port ID for use by the intermediate routers to route the packet to the destination component.

Examples of routing techniques include deterministic routing, which involves choosing the same path from A to B for every packet. This form of routing is independent from the state of the network and does not load balance across path diversities, which might exist in the underlying network. However, such deterministic routing may implemented in hardware, maintains packet ordering and may be rendered free of network level deadlocks. Shortest path routing may minimize the latency as such routing reduces the number of hops from the source to the destination. For this reason, the shortest path may also be the lowest power path for communication between the two components. Dimension-order routing is a form of deterministic shortest path routing in 2-D, 2.5-D, and 3-D mesh networks. In this routing scheme, messages are routed along each coordinates in a particular sequence until the message reaches the final destination. For example in a 3-D mesh network, one may first route along the X dimension until it reaches a router whose X-coordinate is equal to the X-coordinate of the destination router. Next, the message takes a turn and is routed in along Y dimension and finally takes another turn and moves along the Z dimension until the message reaches the final destination router. Dimension ordered routing may be minimal turn and shortest path routing.

FIG. 2A pictorially illustrates an example of XY routing in a two dimensional mesh. More specifically, FIG. 2A illustrates XY routing from node ‘34’ to node ‘00’. In the example of FIG. 2A, each component is connected to only one port of one router. A packet is first routed over the X-axis till the packet reaches node ‘04’ where the X-coordinate of the node is the same as the X-coordinate of the destination node. The packet is next routed over the Y-axis until the packet reaches the destination node.

In heterogeneous mesh topology in which one or more routers or one or more links are absent, dimension order routing may not be feasible between certain source and destination nodes, and alternative paths may have to be taken. The alternative paths may not be shortest or minimum turn.

Source routing and routing using tables are other routing options used in NoC. Adaptive routing can dynamically change the path taken between two points on the network based on the state of the network. This form of routing may be complex to analyze and implement.

A NoC interconnect may contain multiple physical networks. Over each physical network, there exist multiple virtual networks, wherein different message types are transmitted over different virtual networks. In this case, at each physical link or channel, there are multiple virtual channels; each virtual channel may have dedicated buffers at both end points. In any given clock cycle, only one virtual channel can transmit data on the physical channel.

NoC interconnects may employ wormhole routing, wherein, a large message or packet is broken into small pieces known as flits (also referred to as flow control digits). The first flit is a header flit, which holds information about this packet's route and key message level info along with payload data and sets up the routing behavior for all subsequent flits associated with the message. Optionally, one or more body flits follows the header flit, containing remaining payload of data. The final flit is a tail flit, which, in addition to containing last payload, also performs some bookkeeping to close the connection for the message. In wormhole flow control, virtual channels are often implemented.

The physical channels are time sliced into a number of independent logical channels called virtual channels (VCs). VCs provide multiple independent paths to route packets, however they are time-multiplexed on the physical channels. A virtual channel holds the state needed to coordinate the handling of the flits of a packet over a channel. At a minimum, this state identifies the output channel of the current node for the next hop of the route and the state of the virtual channel (idle, waiting for resources, or active). The virtual channel may also include pointers to the flits of the packet that are buffered on the current node and the number of flit buffers available on the next node.

The term “wormhole” plays on the way messages are transmitted over the channels: the output port at the next router can be so short that received data can be translated in the head flit before the full message arrives. This allows the router to quickly set up the route upon arrival of the head flit and then opt out from the rest of the conversation. Since a message is transmitted flit by flit, the message may occupy several flit buffers along its path at different routers, creating a worm-like image.

Based upon the traffic between various end points, and the routes and physical networks that are used for various messages, different physical channels of the NoC interconnect may experience different levels of load and congestion. The capacity of various physical channels of a NoC interconnect is determined by the width of the channel (number of physical wires) and the clock frequency at which it is operating. Various channels of the NoC may operate at different clock frequencies, and various channels may have different widths based on the bandwidth requirement at the channel. The bandwidth requirement at a channel is determined by the flows that traverse over the channel and their bandwidth values. Flows traversing over various NoC channels are affected by the routes taken by various flows. In a mesh or Taurus NoC, there exist multiple route paths of equal length or number of hops between any pair of source and destination nodes. For example, in FIG. 2B, in addition to the standard XY route between nodes 34 and 00, there are additional routes available, such as YX route 203 or a multi-turn route 202 that makes more than one turn from source to destination.

In a NoC with statically allocated routes for various traffic slows, the load at various channels may be controlled by intelligently selecting the routes for various flows. When a large number of traffic flows and substantial path diversity is present, routes can be chosen such that the load on all NoC channels is balanced nearly uniformly, thus avoiding a single point of bottleneck. Once routed, the NoC channel widths can be determined based on the bandwidth demands of flows on the channels. Unfortunately, channel widths cannot be arbitrarily large due to physical hardware design restrictions, such as timing or wiring congestion. There may be a limit on the maximum channel width, thereby putting a limit on the maximum bandwidth of any single NoC channel.

Additionally, wider physical channels may not help in achieving higher bandwidth if messages are short. For example, if a packet is a single flit packet with a 64-bit width, then no matter how wide a channel is, the channel will only be able to carry 64 bits per cycle of data if all packets over the channel are similar. Thus, a channel width is also limited by the message size in the NoC. Due to these limitations on the maximum NoC channel width, a channel may not have enough bandwidth in spite of balancing the routes.

To address the above bandwidth concern, multiple parallel physical NoCs may be used. Each NoC may be called a layer, thus creating a multi-layer NoC architecture. Hosts inject a message on a NoC layer; the message is then routed to the destination on the NoC layer, where it is delivered from the NoC layer to the host. Thus, each layer operates more or less independently from each other, and interactions between layers may only occur during the injection and ejection times. FIG. 3A illustrates a two layer NoC. Here the two NoC layers are shown adjacent to each other on the left and right, with the hosts connected to the NoC replicated in both left and right diagrams. A host is connected to two routers in this example—a router in the first layer shown as R1, and a router is the second layer shown as R2. In this example, the multi-layer NoC is different from the 3D NoC, i.e. multiple layers are on a single silicon die and are used to meet the high bandwidth demands of the communication between hosts on the same silicon die. Messages do not go from one layer to another. For purposes of clarity, the present application will utilize such a horizontal left and right illustration for multi-layer NoC to differentiate from the 3D NoCs, which are illustrated by drawing the NoCs vertically over each other.

In FIG. 3B, a host connected to a router from each layer, R1 and R2 respectively, is illustrated. Each router is connected to other routers in its layer using directional ports 301, and is connected to the host using injection and ejection ports 302. A bridge-logic 303 may sit between the host and the two NoC layers to determine the NoC layer for an outgoing message and sends the message from host to the NoC layer, and also perform the arbitration and multiplexing between incoming messages from the two NoC layers and delivers them to the host.

In a multi-layer NoC, the number of layers needed may depend upon a number of factors such as the aggregate bandwidth requirement of all traffic flows in the system, the routes that are used by various flows, message size distribution, maximum channel width, etc. Once the number of NoC layers in NoC interconnect is determined in a design, different messages and traffic flows may be routed over different NoC layers. Additionally, one may design NoC interconnects such that different layers have different topologies in number of routers, channels and connectivity. The channels in different layers may have different widths based on the flows that traverse over the channel and their bandwidth requirements. With such a large variety of design choices, determining the right design point for a given system remains challenging and remains a time consuming manual process, and often the resulting designs remains sub-optimal and inefficient. A number of innovations to address these problems are described in U.S. patent application Ser. Nos. 13/658,663, 13/752,226, 13/647,557, 13/856,835, 13/723,732, the contents of which are hereby incorporated by reference in their entirety.

System on Chips (SoCs) are becoming increasingly sophisticated, feature rich, and high performance by integrating a growing number of standard processor cores, memory and I/O subsystems, and specialized acceleration IPs. To address this complexity, NoC approach of connecting SoC components is gaining popularity. A NoC can provide connectivity to a plethora of components and interfaces and simultaneously enable rapid design closure by being automatically generated from a high level specification. The specification describes interconnect requirements of SoC in terms of connectivity, bandwidth, and latency. In addition to this, information such as position of various components such as bridges or ports on boundary of hosts, traffic information, chip size information, etc. may be supplied. A NoC compiler (topology generation engine) can then use this specification to automatically design a NoC for the SoC. A number of NoC compilers were introduced in the related art that automatically synthesize a NoC to fit a traffic specification. In such design flows, the synthesized NoC is simulated to evaluate the performance under various operating conditions and to determine whether the specifications are met. This may be necessary because NoC-style interconnects are distributed systems and their dynamic performance characteristics under load are difficult to predict statically and can be very sensitive to a wide variety of parameters. Specifications can also be in the form of power specifications to define power domains, voltage domains, clock domains, and so on, depending on the desired implementation.

Placing hosts/IP cores in a SoC floorplan to optimize the interconnect performance can be important. For example, if two hosts communicate with each other frequently and require higher bandwidth than other interconnects, it may be better to place them closer to each other so that the transactions between these hosts can go over fewer router hops and links and the overall latency and the NoC cost can be reduced.

Assuming that two hosts with certain shapes and sizes cannot spatially overlap with each other on a 2D SoC plane, tradeoffs may need to be made. Moving certain hosts closer to improve inter-communication between them, may force certain other hosts to be further apart, thereby penalizing inter-communication between those other hosts. To make tradeoffs that improve system performance, certain performance metrics such as average global communication latency may be used as an objective function to optimize the SoC architecture with the hosts being placed in a NoC topology. Determining substantially optimal host positions that maximizes the system performance metric may involve analyzing the connectivity and inter-communication properties between all hosts and judiciously placing them onto the 2D NoC topology. In case if inter-communicating hosts are placed far from each other, this can leads to high average and peak structural latencies in number of hops. Such long paths not only increase latency but also adversely affect the interconnect bandwidth, as messages stay in the NoC for longer periods and consume bandwidth of a large number of links.

Also, existing integrated circuits such as programmable logic devices (PLDs) typically utilize “point-to-point” routing, meaning that a path between a source signal generator and one or more destinations is generally fixed at compile time. For example, a typical implementation of an A-to-B connection in a PLD involves connecting logic areas through an interconnect stack of pre-defined horizontal wires. These horizontal wires have a fixed length, are arranged into bundles, and are typically reserved for that A-to-B connection for the entire operation of the PLDs configuration bit stream. Even where a user is able to subsequently change some features of the point-to-point routing, e.g., through partial recompilation, such changes generally apply to block-level replacements, and not to cycle-by-cycle routing implementations.

Such existing routing methods may render the device inefficient, e.g., when the routing is not used every cycle. A first form of inefficiency occurs because of inefficient wire use. In a first example, when an A-to-B connection is rarely used (for example, if the signal value generated by the source logic area at A rarely changes or the destination logic area at B is rarely programmed to be affected by the result), then the conductors used to implement the A-to-B connection may unnecessarily take up metal, power, and/or logic resources. In a second example, when a multiplexed bus having N inputs is implemented in a point-to-point fashion, metal resources may be wasted on routing data from each of the N possible input wires because the multiplexed bus, by definition, outputs only one of the N input wires and ignores the other N−1 input wires. Power resources may also be wasted in these examples when spent in connection with data changes that do not affect a later computation. A more general form of this inefficient wire use occurs when more than one producer generates data that is serialized through a single consumer or the symmetric case where one producer produces data that is used in a round-robin fashion by two or more consumers.

A second form of inefficiency, called slack-based inefficiency, occurs when a wire is used, but below its full potential, e.g., in terms of delay. For example, if the data between a producer and a consumer is required to be transmitted every 300 ps, and the conductor between them is capable of transmitting the data in a faster, 100 ps timescale, then the 200 ps of slack time in which the conductor is idle is a form of inefficiency or wasted bandwidth. These two forms of wire underutilization, e.g., inefficient wire use and slack-based inefficiency, can occur separately or together, leading to inefficient use of resources, and wasting valuable wiring, power, and programmable multiplexing resources.

In many cases, the high-level description of the logic implemented on a PLD may already imply sharing of resources, such as sharing access to an external memory or a high-speed transceiver. To do this, it is common to synthesize higher-level structures representing busses onto PLDs. In one example, a software tool may generate an industry-defined bus as Register-Transfer-Level (RTL)/Verilog logic, which is then synthesized into an FPGA device. In this case, however, that shared bus structure is still implemented in the manner discussed above, meaning that it is actually converted into point-to-point static routing. Even in a scheme involving time-multiplexing of FPGA wires, such as the one proposed on pages 22-28 of Trimberger et. al. “A Time Multiplexed FPGA”, Int'l Symposium on FPGAs, 1997, routing is still limited to an individual-wire basis and does not offer grouping capabilities.

In large-scale networks, efficiency and performance/area tradeoff is of main concern. Mechanisms such as machine learning approach, simulation annealing, among others, provide optimized topology for a system. However, such complex mechanisms have substantial limitations as they involve certain algorithms to automate optimization of layout network, which may violate previously mapped flow's latency constraint or the latency constraint of current flow. Further, it is also to be considered that each user has their own requirements and/or need for SoCs and/or NoCs depending on a diverse applicability of the same. Therefore, there is a need for systems and methods that significantly improve system efficiency by accurately indicating the best possible positions and configurations for hosts and ports within the hosts, along with indicating system level routes to be taken for traffic flows using the NoC interconnect architecture. Systems and methods are also required for automatically generating an optimized topology for a given SoC floor plan and traffic specification with an efficient layout. Further, systems and methods are also required that allows users to specify their requirements for a particular SoC and/or NoC, provides various options for satisfying their requirements and based on this automatically generating an optimized topology for a given SoC floor plan and traffic specification with an efficient layout.

For safe and reliable operation of a device (SoC and/or NoC), error free and fault-tolerant operation of the interconnection networks used in the device is crucial. Random faults can occur in the storage elements and wiring resources used by a system wide interconnect. Such errors must be detected and corrected when possible and all uncorrected errors must be notified to system software for intervention.

Therefore, there exists a need for methods, systems, and computer readable mediums for overcoming the above-mentioned issues with existing implementations of maintaining network-on-chip (NoC) safety and reliability.

### SUMMARY

Methods and example implementations described herein are generally directed to interconnect architecture, and more specifically, to systems and methods for maintaining network-on-chip (NoC) safety and reliability.

Aspects of the present disclosure relate to methods, systems, and computer readable mediums for overcoming the above-mentioned issues with existing implementations by maintaining network-on-chip (NoC) safety and reliability.

An aspect of the present disclosure relates to a network-on-chip (NoC)-based error correction system capable of supporting a network interface (NI) that transmits a flit between a transmission side (Tx) intellectual property (IP) element and a receiving side (Rx) IP element. The system includes an encoder configured to receive a k-bit flit from the Tx IP element and encodes the k-bit flit into n-bit data (where k and n denote any natural numbers), and a decoder configured to receive the n-bit data, decode the n-bit data into the k-bit flit, and output the k-bit flit, the decoder having an error correction circuit for correcting an error in the n-bit data. In an aspect, the error correction circuit comprises a multiple overlapping layers of coverage configured for the NoC transport infrastructure.

In an aspect, the error correction circuit comprises a transport error detection and correction mechanism.

In an aspect, the error correction circuit comprises an end to end transport error checking mechanism. In another aspect, the end to end transport error checking mechanism includes any or combination of data protection Per flit ECC, data error detection Per flit parity, data protection transport of user provided ECC, and sideband protection: ECC or Parity.

In an aspect, the error correction circuit comprises a hop to hop Error checking mechanism. In another aspect, the hop to hop Error checking mechanism includes any or combination of protection of packet control fields, error detection using e2e ECC/Parity, and Implementation of parity check.

In an aspect, the error correction circuit comprises an end to end packet integrity mechanism. In another aspect, the end packet integrity mechanism includes any or combination of detecting misrouted packets, detecting bit interleaved parity, and detecting Flit ID.

In an aspect, the error correction circuit comprises an end to end packet stream integrity mechanism.

An aspect of the present disclosure relates to a method for supporting a network interface (NI) that transmits a flit between a transmission side (Tx) intellectual property (IP) element and a receiving side (Rx) IP element. The method includes the steps of receiving, by an encoder, a k-bit flit from the Tx IP element and encodes the k-bit flit into n-bit data (where k and n denote any natural numbers), and receiving, by a decoder, the n-bit data, decode the n-bit data into the k-bit flit, and output the k-bit flit, the decoder having an error correction circuit for correcting an error in the n-bit data, wherein the error correction circuit comprises a multiple overlapping layers of coverage configured for the NoC transport infrastructure.

In an aspect, the error correction circuit comprises a transport error detection and correction mechanism.

In an aspect, the error correction circuit comprises an end to end transport error checking mechanism. In another aspect, the end to end transport error checking mechanism includes any or combination of data protection Per flit ECC, data error detection Per flit parity, data protection transport of user provided ECC, and sideband protection: ECC or Parity.

In an aspect, the error correction circuit comprises a hop to hop Error checking mechanism. In another aspect, the hop to hop Error checking mechanism includes any or combination of protection of packet control fields, error detection using e2e ECC/Parity, and Implementation of parity check.

In an aspect, the error correction circuit comprises an end to end packet integrity mechanism. In another aspect, the end packet integrity mechanism includes any or combination of detecting misrouted packets, detecting bit interleaved parity, and detecting Flit ID.

In an aspect, the error correction circuit comprises an end to end packet stream integrity mechanism.

An aspect of the present disclosure relates to a non-transitory computer readable storage medium storing instructions for executing a process. The instructions include the steps of receiving, by an encoder, a k-bit flit from the Tx IP element and encodes the k-bit flit into n-bit data (where k and n denote any natural numbers), and receiving, by a decoder, the n-bit data, decode the n-bit data into the k-bit flit, and output the k-bit flit, the decoder having an error correction circuit for correcting an error in the n-bit data, wherein the error correction circuit comprises a multiple overlapping layers of coverage configured for the NoC transport infrastructure.

The foregoing and other objects, features and advantages of the example implementations will be apparent and the following more particular descriptions of example implementations as illustrated in the accompanying drawings wherein like reference numbers generally represent like parts of exemplary implementations of the application.

### BRIEF DESCRIPTION OF DRAWINGS

FIGS. 1A, 1B, 1C, and 1D illustrate examples of Bidirectional ring, 2D Mesh, 2D Taurus, and 3D Mesh NoC Topologies.

FIG. 2A illustrates an example of XY routing in a related art two dimensional mesh.

FIG. 2B illustrates three different routes between a source and destination nodes.

FIG. 3A illustrates an example of a related art two layer NoC interconnect.

FIG. 3B illustrates the related art bridge logic between host and multiple NoC layers.

FIG. 4 illustrates NoC architecture.

FIGS. 5A-5B illustrates functional safety features of a network-on-chip (NoC)-based error correction system.

FIG. 6 illustrates exemplary route duplication between transmitter and receiver end points.

FIG. 7 illustrates an exemplary compound bridge to address redundant port checking.

FIG. 8 illustrates an exemplary flow of a parity check and regeneration implemented in the router in block.

FIG. 9 illustrates an example flow diagram of the network-on-chip (NoC)-based error correction system.

FIG. 10 illustrates an example computer system on which example embodiments may be implemented.

FIGS. 11A and 11B illustrate an example circuit for error detection in the related art, and in accordance with an example implementation respectively.

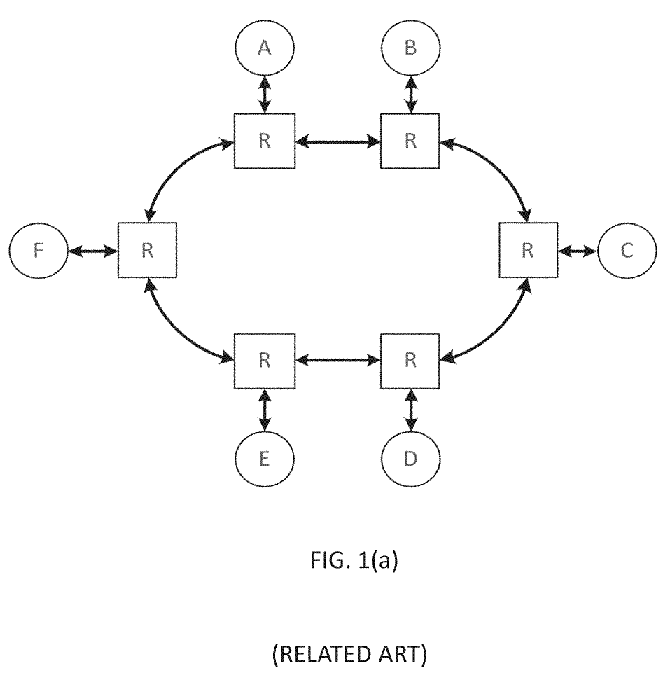

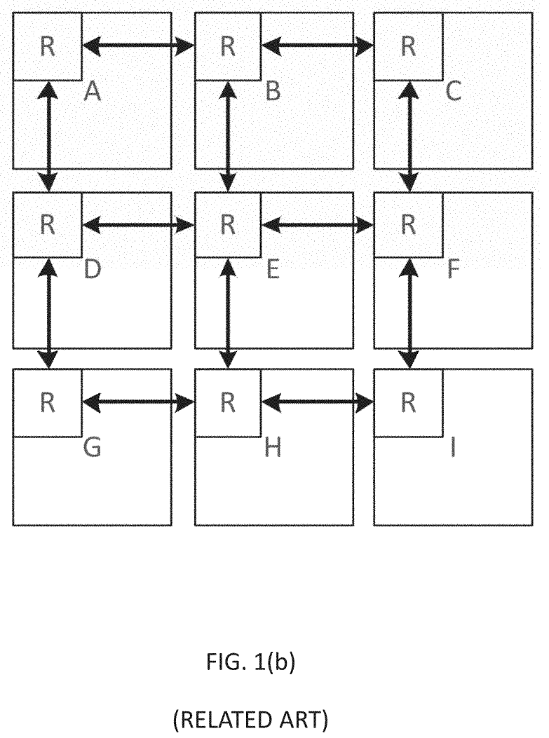

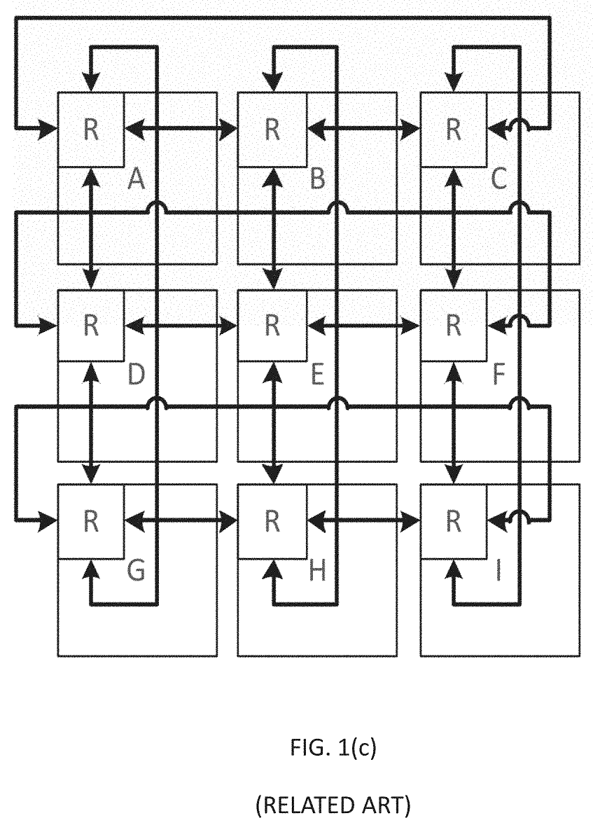

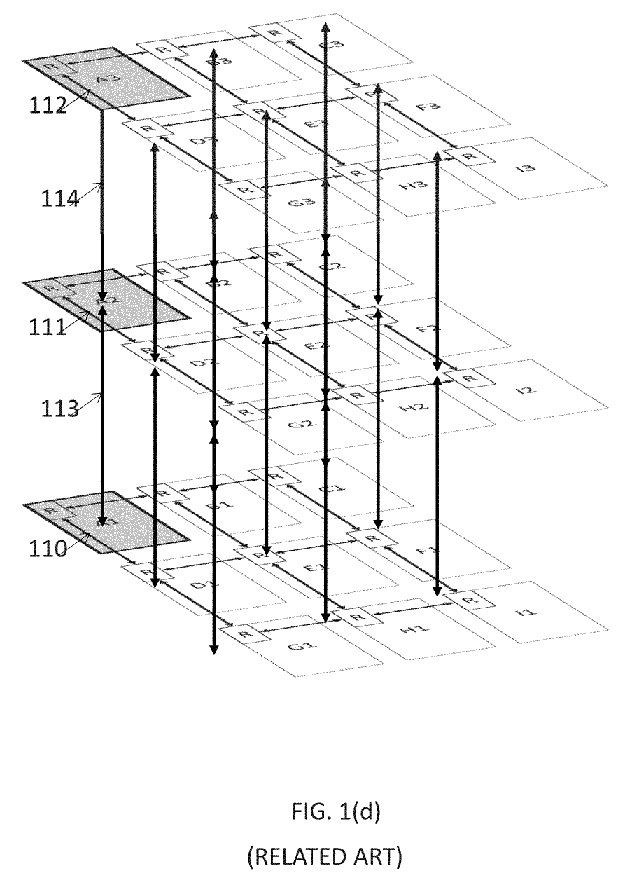

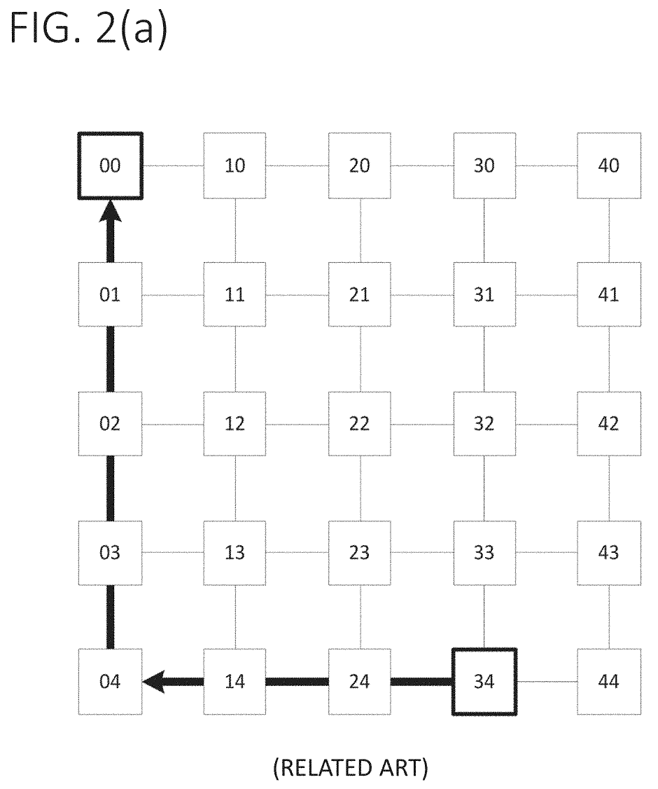

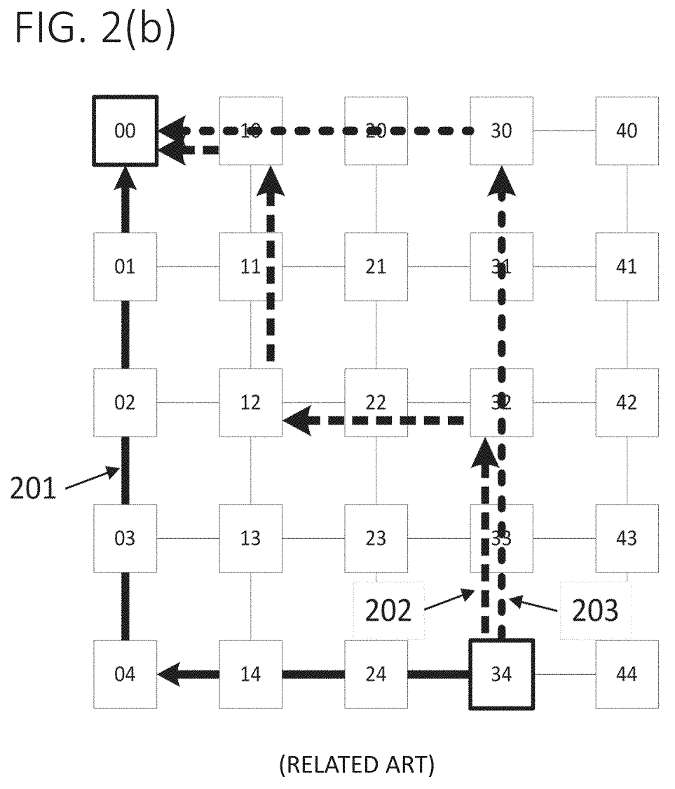

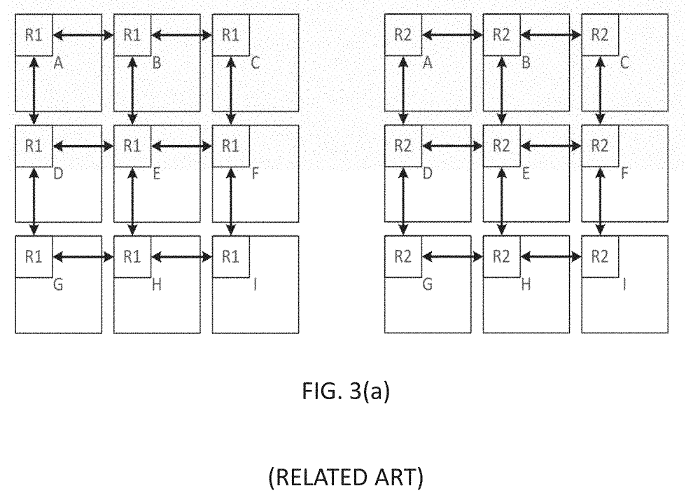

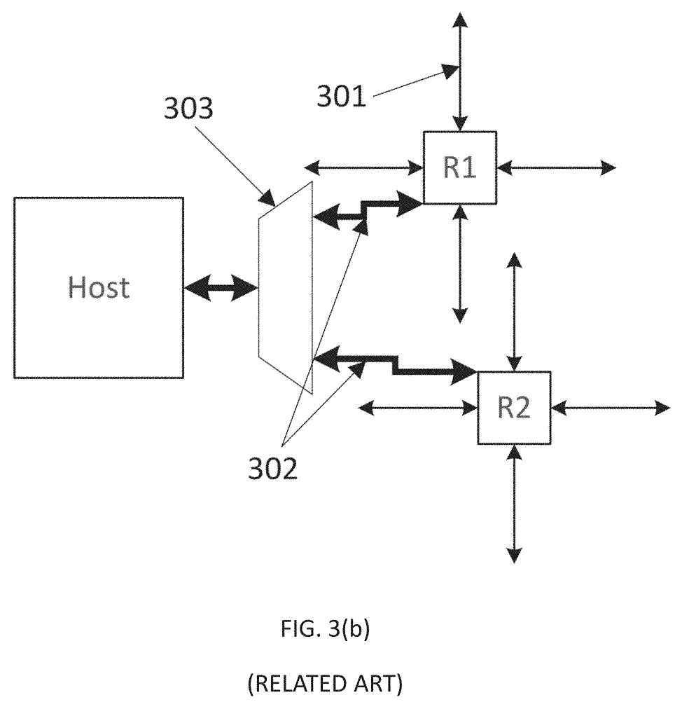

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application.

Network-on-Chip (NoC) has emerged as a paradigm to interconnect a large number of components on the chip. NoC is a global shared communication infrastructure made up of several routing nodes interconnected with each other using point-to-point physical links. In example implementations, a NoC interconnect is generated from a specification by utilizing design tools. The specification can include constraints such as bandwidth/Quality of Service (QoS)/latency attributes that is to be met by the NoC, and can be in various software formats depending on the design tools utilized. Once the NoC is generated through the use of design tools on the specification to meet the specification requirements, the physical architecture can be implemented either by manufacturing a chip layout to facilitate the NoC or by generation of a register transfer level (RTL) for execution on a chip to emulate the generated NoC, depending on the desired implementation. Specifications may be in common power format (CPF), Unified Power Format (UPF), or others according to the desired specification. Specifications can be in the form of traffic specifications indicating the traffic, bandwidth requirements, latency requirements, interconnections, etc. depending on the desired implementation. Specifications can also be in the form of power specifications to define power domains, voltage domains, clock domains, and so on, depending on the desired implementation.

Methods and example implementations described herein are generally directed to interconnect architecture, and more specifically, to systems and methods for maintaining network-on-chip (NoC) safety and reliability.

Aspects of the present disclosure relate to methods, systems, and computer readable mediums for overcoming the above-mentioned issues with existing implementations by maintaining network-on-chip (NoC) safety and reliability.

An aspect of the present disclosure relates to an network-on-chip (NoC)-based error correction system capable of supporting a network interface (NI) that transmits a flit between a transmission side (Tx) intellectual property (IP) element and a receiving side (Rx) IP element. The system includes an encoder configured to receive a k-bit flit from the Tx IP element and encodes the k-bit flit into n-bit data (where k and n denote any natural numbers), and a decoder configured to receive the n-bit data, decode the n-bit data into the k-bit flit, and output the k-bit flit, the decoder having an error correction circuit for correcting an error in the n-bit data. In an aspect, the error correction circuit comprises a multiple overlapping layers of coverage configured for the NoC transport infrastructure.

In an aspect, the error correction circuit comprises a transport error detection and correction mechanism.

In an aspect, the error correction circuit comprises an end to end transport error checking mechanism. In another aspect, the end to end transport error checking mechanism includes any or combination of data protection Per flit ECC, data error detection Per flit parity, data protection transport of user provided ECC, and sideband protection: ECC or Parity.

In an aspect, the error correction circuit comprises a hop to hop Error checking mechanism. In another aspect, the hop to hop Error checking mechanism includes any or combination of protection of packet control fields, error detection using e2e ECC/Parity, and Implementation of parity check.

In an aspect, the error correction circuit comprises an end to end packet integrity mechanism. In another aspect, the end packet integrity mechanism includes any or combination of detecting misrouted packets, detecting bit interleaved parity, and detecting Flit ID.

In an aspect, the error correction circuit comprises an end to end packet stream integrity mechanism.

An aspect of the present disclosure relates to a method for supporting a network interface (NI) that transmits a flit between a transmission side (Tx) intellectual property (IP) element and a receiving side (Rx) IP element. The method includes the steps of receiving, by an encoder, a k-bit flit from the Tx IP element and encodes the k-bit flit into n-bit data (where k and n denote any natural numbers), and receiving, by a decoder, the n-bit data, decode the n-bit data into the k-bit flit, and output the k-bit flit, the decoder having an error correction circuit for correcting an error in the n-bit data, wherein the error correction circuit comprises a multiple overlapping layers of coverage configured for the NoC transport infrastructure.

In an aspect, the error correction circuit comprises a transport error detection and correction mechanism.

In an aspect, the error correction circuit comprises an end to end transport error checking mechanism. In another aspect, the end to end transport error checking mechanism includes any or combination of data protection Per flit ECC, data error detection Per flit parity, data protection transport of user provided ECC, and sideband protection: ECC or Parity.

In an aspect, the error correction circuit comprises a hop to hop Error checking mechanism. In another aspect, the hop to hop Error checking mechanism includes any or combination of protection of packet control fields, error detection using e2e ECC/Parity, and Implementation of parity check.

In an aspect, the error correction circuit comprises an end to end packet integrity mechanism. In another aspect, the end packet integrity mechanism includes any or combination of detecting misrouted packets, detecting bit interleaved parity, and detecting Flit ID.

In an aspect, the error correction circuit comprises an end to end packet stream integrity mechanism.

An aspect of the present disclosure relates to a non-transitory computer readable storage medium storing instructions for executing a process. The instructions include the steps of receiving, by an encoder, a k-bit flit from the Tx IP element and encodes the k-bit flit into n-bit data (where k and n denote any natural numbers), and receiving, by a decoder, the n-bit data, decode the n-bit data into the k-bit flit, and output the k-bit flit, the decoder having an error correction circuit for correcting an error in the n-bit data, wherein the error correction circuit comprises a multiple overlapping layers of coverage configured for the NoC transport infrastructure.

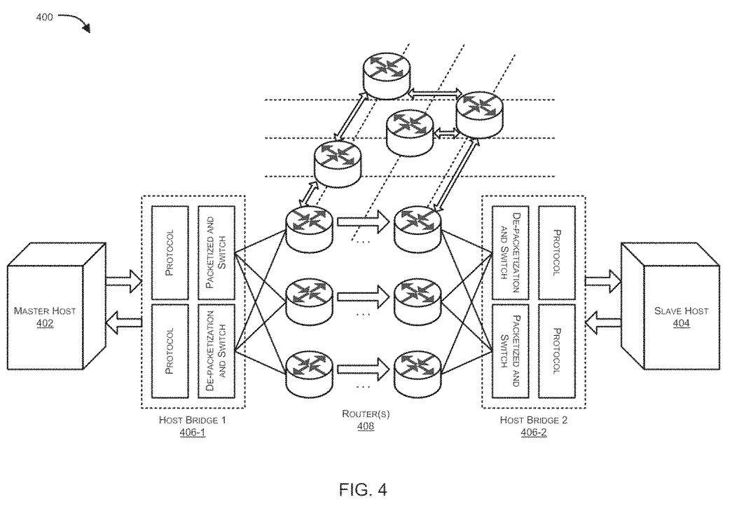

FIG. 4 illustrates NoC architecture 400. In an embodiment, FIG. 4 shows high level architecture of the NoC IP. A bridge (host bridge 1 406-1 and a host bridge 2 406-2) can connect a master host 402 and/or slave host 404 to the NoC and perform the required operations to support the master and slave communication as per the protocol standard. The host bridge 1 406-1 packetizes the master host 402 and the slave host 404 transactions into a specific packet format during injection into the NoC and de-packetizes them during ejection. The host bridge 1 406-1 and a host bridge 2 406-2 connects to a router networks 408. A router (selected from the router networks 408) can have four directional links, referred to as north (N), south (S), east (E), and west (W). It also can have up to four additional links to connect to up to four hosts (H, I, J, K). All eight links are identical and can be attached to bridges or to other routers.

In an exemplary embodiment, for safe and reliable operation of a device, error free and fault-tolerant operation of the interconnection networks used in the device is crucial. Random faults can occur in the storage elements and wiring resources used by a system wide interconnect. Such errors must be detected and corrected when possible and all uncorrected errors must be notified to system software for intervention.

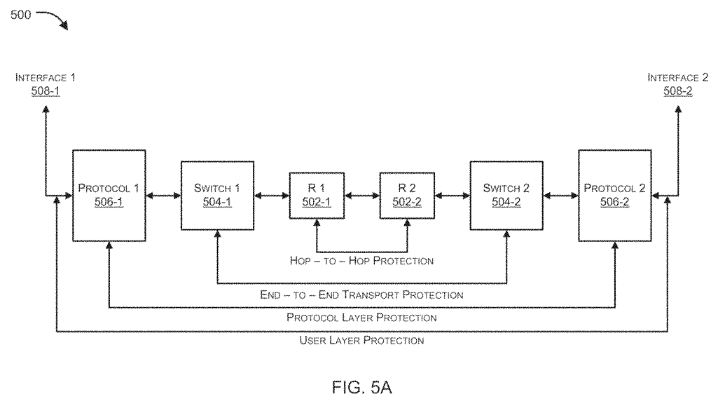

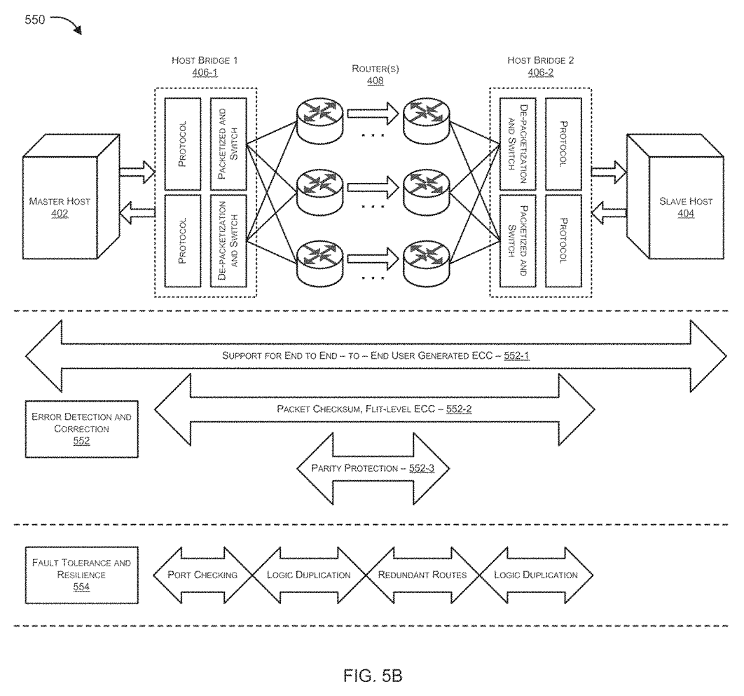

FIGS. 5A-5B illustrates functional safety features of a network-on-chip (NoC)-based error correction system. FIGS. 5A-5B summarizes the functional safety features provided across the different interconnect components. In an embodiment, there are critical parameters for safety and reliability of any network. The critical parameters can include but are not limited to Error detection, error correction and flit level, packet level, and message level. However, error detection is very critical from the above recited critical parameters.

In an embodiment, within NoC-NoC below parameter protections are applicable flit level protection, Packet determination control, Routing information (parity check), Configurable granularity for trade off between area and error coverage, Agents of different widths (which enables software to pick optimal garrulity based on width of the agents and no recompilation when reassigning happens), software based assignment of protection levels (which includes ECC based on different flow in the NoCs, and parity based on different flow in the NoCs, message integrity at packet level by deploying timeouts, request/respond timeouts, transmitter and received endpoints, and agent handshake protocol time outs.

In an exemplary embodiment, the flit level protection which protects the integrity of controls the delivery of the packets for example, starts of packet, end of packet

Referring now to FIG. 5A 500 illustrates overlapping layers and the need for protection at different layers. As shown, a router R 1 502-1 and a router R 2 502-2 in a network can be connected to various components in the network providing different layers of connectivity and operating at different layers.

For example, the Router R 1 502-1 can be connected to switch 1 504-1 working on a specific protocol 1 506-1 providing a specific interface 1 508-1. Similarly, the Router R 2 502-2 can be connected to switch 2 504-2 working on a specific protocol 2 506-2 providing a specific interface 2 508-2.

However, for safe and reliable operation of a device, error free and fault-tolerant operation of the interconnection networks used in the device is crucial. Thus, there is always a need for providing a hop-to-hop protection between two connected routers, say R 1 502-1 and R2 502-1 in this case, and/or end-to-end transport protection between two connected switches, and/or protocol layer protection between two connected protocols, and/or user layer protection between two connected interfaces.

Referring now to FIG. 5B 550, an error detection and correction feature involves various types of protections that are applied for safe and reliable operation of a device and NoC-transport error detection and correction techniques 560, fault tolerance and resilience 562, logic protection and redundancy (not shown), ram protection features (not shown), coherency protection (not shown), timeouts (not shown) being implemented at various levels/layers of the system.

In an embodiment, FIG. 5B 550 shows high level architecture of the NoC IP. A bridge (host bridge 1 406-1 and a host bridge 2 406-2) can connect a master host 402 and/or slave host 404 to the NoC and perform the required operations to support the master and slave communication as per the protocol standard. The host bridge 1 406-1 packetizes the master host 402 and the slave host 404 transactions into a specific packet format during injection into the NoC and de-packetizes them during ejection. The host bridge 1 406-1 and a host bridge 2 406-2 connects to a router networks 408. A router (selected from the router networks 408) can have four directional links, referred to as north (N), south (S), east (E), and west (W). It also can have up to four additional links to connect to up to four hosts (H, I, J, K). All eight links are identical and can be attached to bridges or to other routers.

In an embodiment, the error detection and correction features involve handling errors require first detecting that an error has occurred. The current process for ensuring reliable hardware performance is to detect and correct errors where possible, recover from uncorrectable errors through either physical or logical replacement of a failing component or data path, and prevent future errors by replacing in a timely fashion components most likely to fail. Error correcting codes (ECCs) were devised to enable the detection and correction of errors. One ECC in common use is SECDED (single error correct double error detect), which allows the correction of one bit in an error or detection of a double-bit error in a memory block. Hardware errors can be classified as either (1) detected and corrected errors (DCE) or (2) detected but uncorrected errors (DUE). Handling DCEs is done in silicon using ECCs and can be made transparent to system components. Handling DUES, needs collaboration from multiple levels of abstraction in the hardware-software stack.

In an exemplary embodiment, if the NoC or directory is configured to have ECC (ECC algorithm implemented), the IP implements a customized ECC algorithm. Additional bits are added to the NoC data path and directory RAM array widths to hold ECC information. The bridge packetization and directory control logic handles generating ECC values and checking them in the NoC destination or in the directory read results to confirm that there is no error. The ECC algorithm uses a hamming code with an additional parity bit, sometimes referred to as SECDEC (single error correction, double error detection). The algorithm adds the ECC checkbits to the protected data block, so all bits are protected with single-bit correction, and double-bit dectection. The hardware supports a register mechanism to directly access the directory RAM, including the ECC checkbits. It supports multiple variants, including a method to take an existing directory entry and flip one or more bits before writing it back into the array. This can be used to test ECC logic within the system. The ECC detection and correction can also be disabled via register access.

In an embodiment, the NoC-transport error detection and correction techniques involve end-to-end transport integrity mechanism, end-to-end user protection, Interface Parity, ARM Cortex R5/R7 Port compatibility, Hop-to-hop Protection, and End-to-end Packet Integrity.

In an exemplary embodiment, end-to-end transport integrity can include data ECC protection, data parity protection, and sideband ECC or parity protection.

The data ECC protection can implemented when data (including byte enables) ECC is implemented at the flit/sub-flit level in NoC infrastructure to provide transport integrity. ECC function is single bit correction, double bit detection. To deal with variable width interfaces, ECC is implemented at the granularity of minimum NoC link or user specified granularity, whichever is smaller. Multiple ECC fields are present for wider links. Sideband signal are also protected with ECC. The ECC is created at the ingress point and the default mode is for ECC to be checked at egress from the network for the packetized transaction. However, at the expense of additional area, error detection and correction can be configured to be added on a per-hop basis inside the NoC increasing robustness.

The data parity protection can include ECC detection and correction comes at a cost to area, and hence the present invention provides the user with the option to implement data parity. The granularity and coverage of the protection is similar to the ECC methodology. Data parity does not cause any latency additions to the path

The sideband ECC or parity protection enables to protect the information carried in packet sideband, with end-to-end ECC or parity. At the transmitting end, ECC is calculated on sideband segments at the selected granularity and at the receiving end, error detection and correction is performed.

In an exemplary embodiment, end-to-end user protection enables to provide the user a configurable option to generate their own ECC and the NoC transports them to the receiving end. The protection mechanism passes host generated ECC in data and control packets using user-bit fields. The ECC information originates and terminates in the host logic.

In an exemplary embodiment, interface parity enables the NoC to provide advanced parity protection on the interface to the hosts. This adds protection for the data path from the host IPs into the bridges. This also offers coverage of the ASYNC FIFO, skid stage and ratio sync buffer. The coverage and granularity provided by the parity protection depends on the type of signals and varies between the various channels. For example, for the data interface, the granularity is configurable all the way from one bit for all data bits or one bit per 8-bits. Parity is valid for every beat of information on these interfaces and the parity is checked off at the receiving end of the same interface before any transformation is performed within the bridge. This augmented with the NoC End-to-end transport integrity, provides a true End-to-end from host to host.

In an exemplary embodiment, with the advent of cores built for these markets, some interfaces already have protection related signals defined and associated as part of the physical ports. The ARM Cortex R5/R7 Port compatibility enables to have ports protected with ECC and parity for the various parts of the interface. The present invention provides the option to generate ECC and parity compatible with the AXI port protection in the ARM Cortex R5/R7 cores. This not only eases user integration but more importantly leverages some of these interface features.

In an exemplary embodiment, the hop-to-hop protection includes a control parity protection and error detection using e2e ECC/Parity.

The hop-to-hop protection includes Detection and correction of ECC comes at a cost of area and latency. In an exemplary embodiment the present invention provides the user with an additional configurable option of data error detection (only) at a hop-to-hop basis, using the ECC or Parity carried to protect the data and sideband. This does not incur extra latency, since it is only detection, but provides a way to localize any error, and to identify any issue sooner, rather than waiting until a check at the receiver.

The end-to-end packet integrity provides robust means of confirming integrity at the packet level to detect missing data or misrouted packets. A packet can be made up of multiple flits, and additional protection is needed to check for integrity of complete packets exchanged on the NoC. This is done by including a checksum that covers the entire transaction payload (including any address and control fields that must pass unaltered end to end) as well as some basic identifying information such as destination ID, source ID, sequence number, etc. Advanced techniques such as bit interleaved parity and flit identifiers further enhance the robustness of the IP by ensuring tolerance to errors. All these techniques are configurable to provide users with the ability to choose the desired level of protection vs. cost tradeoff.

In an embodiment, the present invention also includes a mechanism of logic protection and redundancy which further includes a flop structure parity protection, bridge duplication, route duplication, architectural support for redundancy, and NoC register parity checking.

In an exemplary embodiment, once the transaction is framed into a packet, IP can verify correct transmission through the mechanism described in previous sections. However, to guarantee end-to-end resilience, we need to protect the logic that frames the transaction on ingress and unpacks it at the egress. This is done by having duplicated logic with equivalence check at the bridges.

The flop structure parity protection as a first line of defense, the present invention provides the option to protect the large logic structures with parity. This comes at a low cost compared to duplication. Key design features including buffers, flop arrays, registers, constant parameter arrays, can be configured to be protected with parity to ensure that faults can be detected, in these structures that are an integral part of the path. This applies to the flop structures in the following components, such as but not limited to, Bridges, Routers, CCC (cache coherency controller), IOCB (TO coherent bridge), LLC (last level cache), DAU (deadlock avoidance unit).

The bridge duplication enables the systems that require a higher level of protection, to provide the configurable option to duplicate entire bridges. This provides the utmost protection of the bridges from errors. To ensure that the redundant unit is not similarly affected by error as the original, isolation is achieved by delaying the redundant unit by a clock cycle. Also a separate clock and reset input are provided to isolate them from glitches

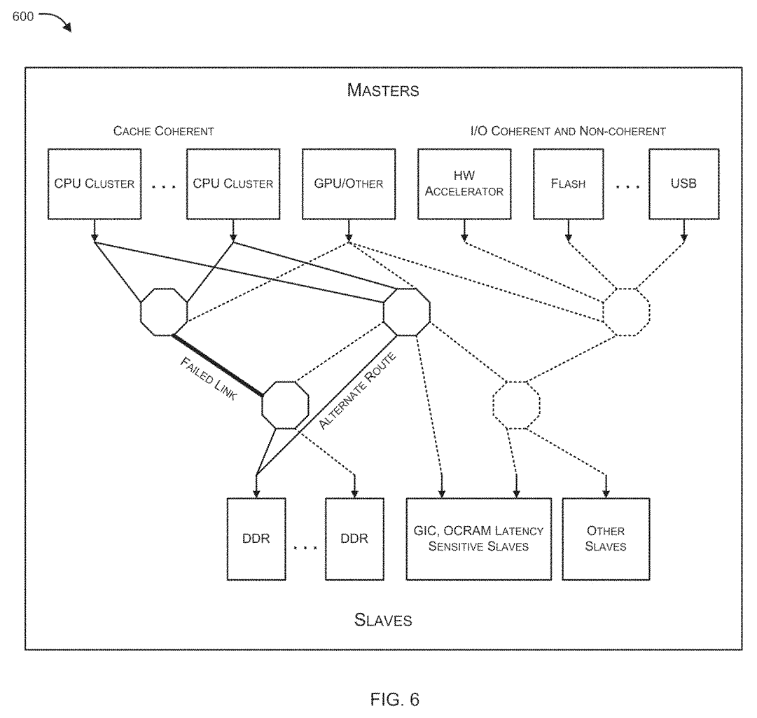

The route duplication enables the one other piece of the data path that needs protection is the actual routes between the bridges. This is accomplished in an algorithmic way by duplicating entire routes between transmitter and receiver end points. Only one physical route would be active at any given instant, but under software control the routes can be changed and swapped. If a route is compromised due to errors, the software (SW) would have control to swap to a different route. This is completely under software control and most importantly has a very low area overhead compared to duplication of the routers themselves as illustrated in FIG. 6

FIG. 6 600 illustrates exemplary route duplication between transmitter and receiver end points. As shown the route duplication enables to find the design time configurable to support multiple routes, find the boot time support to pick initial set of routers, run-time programmable to switch under software control. Further, the exemplary route duplication also provides a complete physical isolation of the various components of the system by providing no sharing of resource links and routers between routes and the each route can be individually optimized for PPA. Furthermore, the exemplary route duplication also enables mix-n-match support depending on individual master-slave requirements, and automated scalable route optimization to TTM.

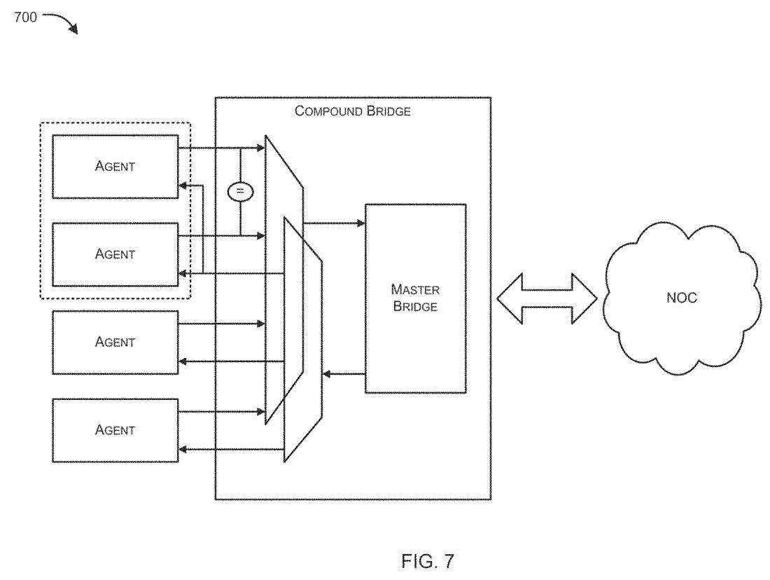

In an exemplary embodiment, the architectural support for redundancy resolves the hardware errors which can affect computed results, data stored in memory, and data in transit between components. Such errors affect the accuracy, reliability, and integrity of computations. Hardware errors fall into two categories: soft errors and hard errors. Soft errors mostly occur because of random events affecting electronic circuits at the molecular level, such as alpha particles or cosmic rays dislodging electrons and therefore moving charges from one part of a circuit to another. Hard errors are permanent physical failures at the hardware level, e.g., a stuck bit in a data bus, a bad bit in a memory module, or a faulty internal circuit in a processor. To address these errors, mission-critical SoCs employ lock step processor cores and other redundant computing elements. To handle these elements, the present invention uses a compound bridge, as shown in the FIG. 7 700 which illustrates an exemplary compound bridge (implemented as software) to address redundant port checking, to compare AXI interfaces and confirms that they are lock-step equivalent.

In an exemplary embodiment, the present invention also provides a mechanism for NoC register parity checking to achieve safe and reliable operations. The present invention can be configured to enable parity on all NoC registers. If enabled, parity bits are stored with write (or at reset) and verified by SW (software) on reads. Parity is generated at regbus master and carried through the NoC. The hardware components that use register values, checks for parity whenever they use the value, and if there is a parity mismatch, the operation is modified as appropriate for the circumstance. Apart from this the parity is also checked every cycle. For example: address table parity failure would force a DECERR response that terminates the transaction.

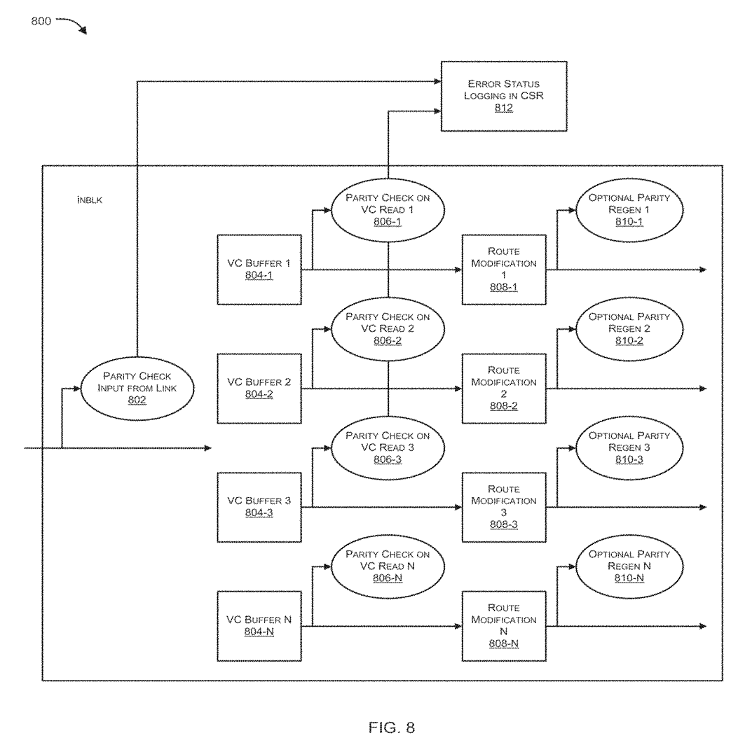

FIG. 8 illustrates an exemplary flow of a parity check and regeneration implemented in the router in block. As shown in FIG. 8 800 an input block of transmitter or receiver configured to receive a packet can include parity check input from link 802, which can be distributed across one or more VC buffers, say VC buffer 1 804-1, VC buffer 2 804-2, VC buffer 3 804-3 and VC buffer N 804-N, which further sends the packet for route modification blocks, say route modification 1 808-1 block, route modification 2 808-2 block, route modification 3 808-3 block, and route modification N 808-N block, after performing parity check by passing through parity check on VC read 1 806-1, parity check on VC read 2 806-2, parity check on VC read 3 806-3, and parity check on VC read N 806-N. Each packet when passing through the blocks parity check input from link, VC buffer, parity check on VC read, the activity associated with the packet is logged into error status logging in CSR 812 block

In an exemplary embodiment, the preset invention also provides a ram protection features which can include but are not limited to, data ECC for RAMs and address ECC for RAMs. The Data ECC for RAMs enables the coherency directory and last level cache RAMs support ECC single-bit correction and double-bit detection. The number of ECC checkbits is derived from the number of data bits needed. The address ECC for RAMs, apart from the data array, enables to protect the address decode/lookup functionality of the RAM too allowing failures in that logic to be detected. The goal here is to have the ECC computed not just based on the data but also the array address. This level of protection is vital in safety critical applications to detect potential issues causing incorrect rows to be read form the RAMs.

In another exemplary embodiment, the preset invention also provides coherency protection, and timeouts. The coherency protection enables to protect all its coherency components, logic and memory included. It may be appreciated that, the various mechanisms are disclosed above also apply to coherent as well as non-coherent components of the IP.

While implementing timeouts, it may be appreciated that there are various configurable options for handling timeouts in any IP, using high resolution counters with programmable timestamps. Maskable interrupt is also raised to the CPU with detailed syndrome of the timed-out request. In an exemplary embodiment, the timeouts can include, but are not limited to, target timeouts, initiator timeouts, and NoC Timeouts.

The target timeouts can be used to detect unresponsive targets, timeouts track requests outstanding to slave devices at the target side NoC bridges. When responses are not received from the target within timeout intervals, dummy error responses can be optionally auto-generated and sent back to the initiator. This allows recovery of reserved resources in the NoC and the initiator.

The initiator timeouts, on initiator side bridges, can be maintained for transactions outstanding on the NoC. These timeouts allow detection of requests potentially dropped or stuck in the NoC. Timeout intervals are individually programmable and share timers for low cost implementation

The NoC Timeouts can provide another layer of timeouts occur based on backpressure from the slave device for requests and master devices for responses from NoC. This can cause backup in the NoC potentially blocking other traffic. Timeout for these events can be configured to start dropping requests or response at the destination and raise fatal interrupts for CPU intervention.

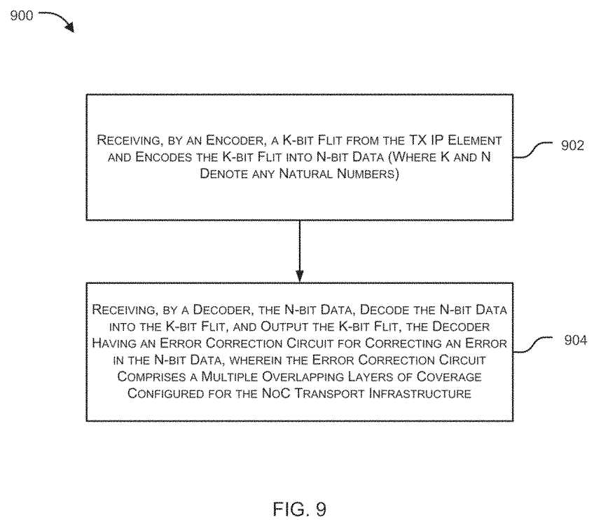

FIG. 9 illustrates an example flow diagram of the network-on-chip (NoC)-based error correction system. In an exemplary embodiment, a method 900 for supporting a network interface (NI) that transmits a flit between a transmission side (Tx) intellectual property (IP) element and a receiving side (Rx) IP element is disclosed. At step 902, an encoder receives a k-bit flit from the Tx IP element and encodes the k-bit flit into n-bit data (where k and n denote any natural numbers). At step 904, a decoder receives the n-bit data, decode the n-bit data into the k-bit flit, and output the k-bit flit, the decoder having an error correction circuit for correcting an error in the n-bit data, wherein the error correction circuit comprises a multiple overlapping layers of coverage configured for the NoC transport infrastructure.

In an aspect, the error correction circuit comprises a transport error detection and correction mechanism.

In an aspect, the error correction circuit comprises an end to end transport error checking mechanism. In another aspect, the end to end transport error checking mechanism includes any or combination of data protection Per flit ECC, data error detection Per flit parity, data protection transport of user provided ECC, and sideband protection: ECC or Parity.

In an aspect, the error correction circuit comprises a hop to hop Error checking mechanism. In another aspect, the hop to hop Error checking mechanism includes any or combination of protection of packet control fields, error detection using e2e ECC/Parity, and Implementation of parity check.

In an aspect, the error correction circuit comprises an end to end packet integrity mechanism. In another aspect, the end packet integrity mechanism includes any or combination of detecting misrouted packets, detecting bit interleaved parity, and detecting Flit ID.

In an aspect, the error correction circuit comprises an end to end packet stream integrity mechanism.

In an embodiment, the transport error detection and correction is required since, Data is exchanged between agents through the NoC using a packet protocol. Different levels of transport error resilience can be configured for the NoC transport infrastructure. Packets transported over the NoC can be broadly viewed as comprising of three fields i. Data field ii. Sideband field, and iii. Packet control fields.

The data field can be usually some power of two multiple of an integer number of bits. Interfaces to agents and data part of NoC links belong to this category. This part can undergo upsizing and downsizing while being transported across the NoC. The Sideband field is, for example, AW command carried on sideband of the AWW channel. This field does not undergo resizing through the network. The Packet control fields include signals for routing, delineation, credit return etc.

In an embodiment, the end to end transport error checking is required since any flow through the NoC can be configured to provide error checking using ECC or parity. ECC uses hamming code with additional parity bit to provide SECDED code. This code can correct single bit errors and detect double bit errors in a block of data. Parity only allows detection of odd number of bit errors.

In an exemplary embedment, the end to end transport error checking can further include data protection for per flit ECC, data error detection for per flit parity, data protection for transport of user provided ECC, and sideband protection for ECC or parity.

The data protection for per flit ECC can be required since on a transmit bridge for every layer with ECC protection enabled, ECC is calculated over each data flit and sent along with the flit. At the receiving end, ECC is used to detect and correct any errors in the data flit received from NoC layer before delivering to the receive host interface. Granularity of data width over which ECC is computed is derived and configured by NocStudio globally on each NoC layer. Smallest possible granularity is the CELL SIZE configured on that layer. However if the narrowest interface communicating on that layer or narrowest NoC link on that layer is N*CELL_SIZE, then this must be the granularity over which ECC is computed. Note that narrower granularity increases area overhead for ECC but provides higher detection and correction coverage. Configured granularity is a power-of-2 multiple of cell size on a layer. An example is regbus layer, where each interface is typically 36-bits (4-cells), but NoC links can be as narrow as 9-bits (1-cell) if downsizing is performed. In this case, ECC granularity would be 9-bits. In an exemplary implementation, user can specify a maximum granularity over which ECC is to be computed. Consider a NoC where all host interfaces are 512-bits with no downsizing in the NoC. In this case, the default ECC calculation granularity will be 512-bits. However, the user may choose to specify a smaller granularity of 64-bits for ECC computation to allow better timing performance. In summary, global granularity selected by NocStudio for ECC computation will be the smaller value between narrowest link/interface width and user specified maximum granularity. Every cycle, Multiple ECC/Parity code words are computed in parallel, one for each ‘granularity’ wide segment of data/sideband of the flit. Computed ECC is transported similar to data flits and will undergo upsizing and downsizing with its associated data flit. ECC generation at the transmitting end and detection and correction at the receiving end will add a cycle each to overall path latency.

The data error detection for per flit parity can be used as an alternative to ECC, where user may configure parity to be transported with the data flits for detecting odd number of bit errors. Granularity of data width over which parity is calculated and transported is as specified for ECC. Parity based protection does not add latency to the path.

The data protection for transport of user provided ECC is an Another alternative allows the use to generate ECC on the data and provide it on the interface using USER bits. In this case, NoC merely transports the ECC bits from transmitting to receiving end. Note that this option is only applicable to DATA flits which do not undergo any modification in the NoC. Command fields can be modified by the NoC and hence user provided ECC will lose its integrity. The user provided ECC should be provided per byte of data through the ‘Per byte user bits’ interface. This is transported in the data cells and can hence undergo upsizing/downsizing in the NoC.

The sideband protection for ECC or parity can be Similar to data, information carried in packet sideband will be protected end-to-end using ECC or parity. Sideband associated with an interface has the same width over the entire network, this field does not undergo upsizing/downsizing in the NoC. Sideband width is increased to the next multiple of ECC computation granularity using msb 0 padding. At the transmitting end, ECC is calculated on sideband segments at the selected granularity and at the receiving end, error detection and correction is performed.

In an exemplary embodiment, hop to hop error checking is required If data or user side band is protected by ECC, then error check operations on these fields are only performed at the NoC endpoints. However if parity is applied to data and sideband, then parity error detection on these fields occurs at every hop of the network. Similarly, other fields of packet are covered by parity error detection at every hop of the network. The hop to hop error checking can include protection of packet control fields, and error detection using e2e ECC/Parity.

The packet control fields can be associated with every packet flit can undergo modifications as the packet is routed over the NoC. At the transmitter, parity is calculated over these fields and sent along with the flit. At every downstream hop, parity field is used to detect any error and may be recomputed for the next hop. A dedicated parity bit is used to protect each of these signal groups.

In an example, the packet delineation fields can include various fields as illustrated in the table below:

| Name | Width | |
|---|---|---|
| flit_valid | 4 | Flit valid |
| flit_sop | 1 | Start of packet |
| flit_eop | 1 | End of packet |
| flit_bv | log2(DATA_WIDTH) | This signal is present only on the |
| | | router links. This indicates the |
| | | number of cells valid in the EOP flit |
| | | of a packet. |

In an example, the Packet routing information can include various fields as illustrated in the table below:

| Name | Width | |
|---|---|---|
| flit_route_info | P_ROUTE_INFO_WIDTH | Routing information |
| req_outp | 3 | Next hop output port |

In an example, the Link flow-control credits can include various fields as illustrated in the table below:

| Name | Width | |
|---|---|---|
| credit_inc | 4 | Credit return |

The error detection using e2e ECC/Parity enables the user selectable options which allow error detection (only) at each hop of the NoC, using the ECC or Parity fields carried to protect data and sideband end-to-end.

In an example, the error detection using e2e ECC/Parity can include various fields as illustrated in the table below:

| Name | Width | |
|---|---|---|
| flit_data | P_DATA_WIDTH | Packet data. Protected end-to-end |
| | | using ECC or Parity. Optional per |
| | | hop error check. |
| flit_usrsb | P_USRSB_WIDTH | Packet side band. Protected end-to- |
| | | end using ECC or Parity. Optional |
| | | per hop error check. |

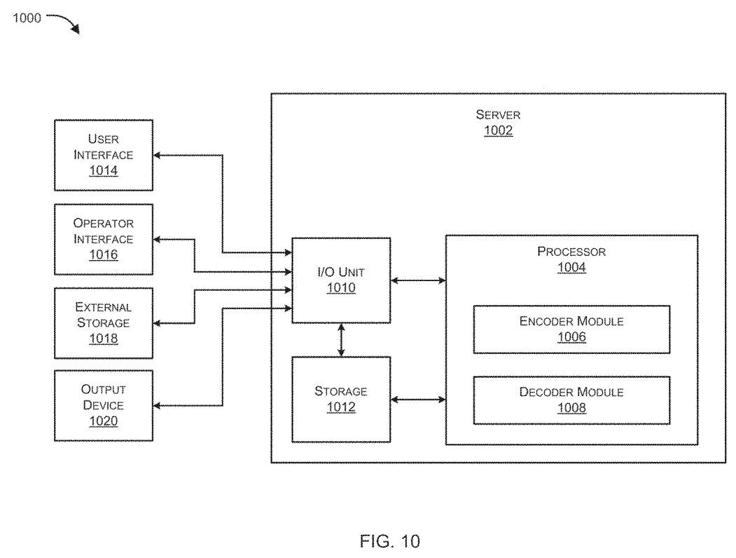

FIG. 10 illustrates an example computer system on which example embodiments may be implemented. This example system is merely illustrative, and other modules or functional partitioning may therefore be substituted as would be understood by those skilled in the art. Further, this system may be modified by adding, deleting, or modifying modules and operations without departing from the scope of the inventive concept.

In an aspect, computer system 1000 includes a server 1002 that may involve an I/O unit 1010, storage 1012, and a processor 1004 operable to execute one or more units as known to one skilled in the art. The term “computer-readable medium” as used herein refers to any medium that participates in providing instructions to processor 1004 for execution, which may come in the form of computer-readable storage mediums, such as, but not limited to optical disks, magnetic disks, read-only memories, random access memories, solid state devices and drives, or any other types of tangible media suitable for storing electronic information, or computer-readable signal mediums, which can include transitory media such as carrier waves. The I/O unit processes input from user interfaces 1014 and operator interfaces 1016 which may utilize input devices such as a keyboard, mouse, touch device, or verbal command

The server 1002 may also be connected to an external storage 1018, which can contain removable storage such as a portable hard drive, optical media (CD or DVD), disk media or any other medium from which a computer can read executable code. The server may also be connected an output device 1020, such as a display to output data and other information to a user, as well as request additional information from a user. The connections from the server 1002 to the user interface 1014, the operator interface 1016, the external storage 1018, and the output device 1020 may via wireless protocols, such as the 802.11 standards, Bluetooth® or cellular protocols, or via physical transmission media, such as cables or fiber optics. The output device 1020 may therefore further act as an input device for interacting with a user.

The processor 1004 may execute one or more modules including includes an encoder module 1006 configured to receive a k-bit flit from the Tx IP element and encodes the k-bit flit into n-bit data (where k and n denote any natural numbers), and a decoder module 1008 configured to receive the n-bit data, decode the n-bit data into the k-bit flit, and output the k-bit flit, the decoder having an error correction circuit for correcting an error in the n-bit data. In an aspect, the error correction circuit comprises a multiple overlapping layers of coverage configured for the NoC transport infrastructure.

In an aspect, the error correction circuit comprises a transport error detection and correction mechanism.

In an aspect, the error correction circuit comprises an end to end transport error checking mechanism. In another aspect, the end to end transport error checking mechanism includes any or combination of data protection Per flit ECC, data error detection Per flit parity, data protection transport of user provided ECC, and sideband protection: ECC or Parity.

In an aspect, the error correction circuit comprises a hop to hop Error checking mechanism. In another aspect, the hop to hop Error checking mechanism includes any or combination of protection of packet control fields, error detection using e2e ECC/Parity, and Implementation of parity check.

In an aspect, the error correction circuit comprises an end to end packet integrity mechanism. In another aspect, the end packet integrity mechanism includes any or combination of detecting misrouted packets, detecting bit interleaved parity, and detecting Flit ID.

In an aspect, the error correction circuit comprises an end to end packet stream integrity mechanism.

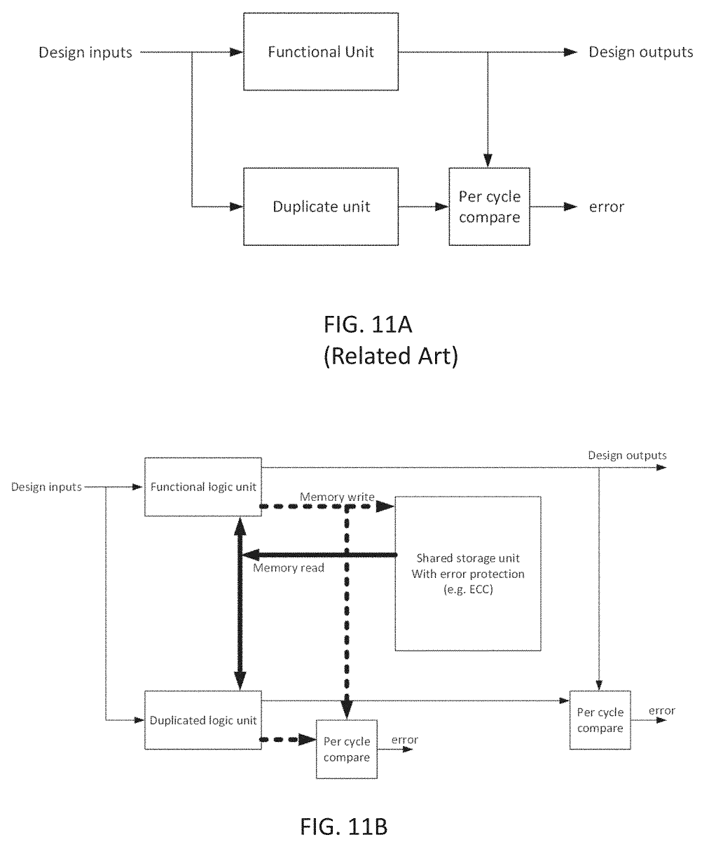

FIGS. 11A and 11B illustrate an example circuit for error detection in the related art, and in accordance with an example implementation respectively.

As shown in FIG. 11A, a strategy for error detection in the related art involves duplication of the functional unit. Such related art approaches involving having a complete duplicate of the functional unit for which error detection is desired. Both units are fed the exact same design inputs and their design outputs are compared every cycle through a circuit configured to do comparisons of the output per cycle. A difference in the outputs is a detection of error in one of the units, and that error is then provided. However, such related art implementations involving duplication for error detection doubles the area and power cost of the circuit design.

To address the above issues in the related art, example implementations are directed to a circuit design that avoids full duplication through utilization of a shared memory as shown in FIG. 11B. In the example illustrated in FIG. 11B, the proposed design partitions the functional unit into logic blocks and storage structures. Only lower cost logic units are fully duplicated in the duplicated logic unit. Large storage structures are shared between the functional unit and duplicate unit. The storage structures themselves are protected against errors by using error detection mechanisms such as parity or ECC. The logic unit involves combinatorial logic and fewer state and control flops. Storage unit involves large flip-flop arrays or memory blocks in accordance with the desired implementation.

As shown in FIG. 11B, only the functional unit writes and updates the memory. However, the write contents are compared against the memory write outputs generated by the duplicate logic unit to detect any mismatch. Contents read from the storage structure are fed to both functional and duplicate logic units

In this manner, the duplicated logic unit does not have to be a full duplication of the functional unit to be tested, which thereby saves on area and power cost through the utilization of a shared memory unit. Further, the functional unit and the duplicated logic unit thereby do not each have to utilize their own memory unit, but share off the same memory unit to save on area cost.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present disclosure. Further, some example implementations of the present disclosure may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the example implementations disclosed herein. Various aspects and/or components of the described example implementations may be used singly or in any combination. It is intended that the specification and examples be considered as examples, with a true scope and spirit of the application being indicated by the following claims.

What is claimed is:

1. An network-on-chip (NoC)-based error correction system capable of supporting a network interface (NI) that transmits a flit between a transmission side (Tx) intellectual property (IP) element and a receiving side (Rx) IP element, the system comprising:
an encoder configured to receive a k-bit flit from the Tx IP element and encodes the k-bit flit into n-bit data (where k and n denote any natural numbers);
a decoder configured to receive the n-bit data, decode the n-bit data into the k-bit flit, and output the k-bit flit, the decoder having an error correction circuit for correcting an error in the n-bit data, wherein the error correction circuit comprises a multiple overlapping layers of coverage configured for the NoC transport infrastructure.

2. The NoC-based error correction system of claim 1, wherein the error correction circuit comprises a transport error detection and correction mechanism.

3. The NoC-based error correction system of claim 1, wherein the error correction circuit comprises an end to end transport error checking mechanism.

4. The NoC-based error correction system of claim 3, wherein the end to end transport error checking mechanism includes any or combination of data protection Per flit ECC, data error detection Per flit parity, data protection transport of user provided ECC, and sideband protection: ECC or Parity.

5. The NoC-based error correction system of claim 1, wherein the error correction circuit comprises a hop to hop Error checking mechanism.

6. The NoC-based error correction system of claim 5, wherein the hop to hop Error checking mechanism includes any or combination of protection of packet control fields, error detection using e2e ECC/Parity, and implementation of parity check.

7. The NoC-based error correction system of claim 1, wherein the error correction circuit comprises an end to end packet integrity mechanism.

8. The NoC-based error correction system of claim 7, wherein the end packet integrity mechanism includes any or combination of detecting misrouted packets, detecting bit interleaved parity, and detecting Flit ID.

9. The NoC-based error correction system of claim 1, wherein the error correction circuit comprises an end to end packet stream integrity mechanism.

10. A method for supporting a network interface (NI) that transmits a flit between a transmission side (Tx) intellectual property (IP) element and a receiving side (Rx) IP element, comprising:
receiving, by an encoder, a k-bit flit from the Tx IP element and encodes the k-bit flit into n-bit data (where k and n denote any natural numbers); and
receiving, by a decoder, the n-bit data, decode the n-bit data into the k-bit flit, and output the k-bit flit, the decoder having an error correction circuit for correcting an error in the n-bit data, wherein the error correction circuit comprises a multiple overlapping layers of coverage configured for the NoC transport infrastructure.

11. The method of claim 11, wherein the error correction circuit comprises a transport error detection and correction mechanism.

12. The method of claim 11, wherein the error correction circuit comprises an end to end transport error checking mechanism.

13. The method of claim 14, wherein the end to end transport error checking mechanism includes any or combination of data protection Per flit ECC, data error detection Per flit parity, data protection transport of user provided ECC, and sideband protection: ECC or Parity.

14. The method of claim 11, wherein the error correction circuit comprises a hop to hop Error checking mechanism.

15. The method of claim 14, wherein the hop to hop Error checking mechanism includes any or combination of protection of packet control fields, error detection using e2e ECC/Parity, and 1.3.3 Implementation of parity check.

16. The method of claim 11, wherein the error correction circuit comprises an end to end packet integrity mechanism.

17. The method of claim 16, wherein the end packet integrity mechanism includes any or combination of detecting misrouted packets, detecting bit interleaved parity, and detecting Flit ID.

18. The method of claim 11, wherein the error correction circuit comprises an end to end packet stream integrity mechanism.
